(19) United States
(12) Patent Application Publication
(10) Pub. No.: US 2026/0235770 A1
(43) Pub. Date: Aug. 13, 2026

(54) Methods to Facilitate GNSS Measurement for an IoT NTN UE

(71) Applicant: Telefonaktiebolaget LM Ericsson (publ), Stockholm (SE)

(72) Inventors: Talha Khan, Santa Clara, CA (US); Johan Rune, Lidingö (SE); Emre Yavuz, Stockholm (SE)

(21) Appl. No.: 19/473,066

(22) PCT Filed: Apr. 4, 2024
(86) PCT No.: PCT/EP2024/059202

§ 371 Date: Oct. 6, 2025

Related U.S. Application Data
(60) Provisional application No. 63/457,863, filed on Apr. 7, 2023.

(51) Int. Cl. G01S 19/25; H04W 24/08; H04W 64/00; H04W 84/06

(52) U.S. Cl. CPC G01S 19/25; H04W 24/08; H04W 64/00; H04W 84/06

(57) ABSTRACT

Methods, apparatuses, and systems for performing Global Navigation Satellite System, GNSS, measurements and for facilitating such measurements An example method, in a user equipment, UE, comprises the step of receiving (410) an indication of a selection of a type of GNSS measurement to be performed by the UE from among at least two of: an aperiodic GNSS measurement, an event-based GNSS measurement, a time-periodic GNSS measurement, and a periodic GNSS measurement, where ‘periodic GNSS measurement’ encompasses both time-periodic GNSS measurements and event-based GNSS measurements. The example method further comprises performing (420) one or more GNSS measurements in accordance with the indication.

### TECHNICAL FIELD

The present disclosure is generally related to wireless communications and is more particularly related to techniques for performing positioning measurements, by a user equipment, when operating in a non-terrestrial network (NTN).

### BACKGROUND

There is an ongoing resurgence of satellite communications. Several plans for satellite networks have been announced in the past few years. Satellite networks could complement mobile networks on the ground by providing connectivity to underserved areas and multicast/broadcast services.

To benefit from the strong mobile ecosystem and economy of scale, adapting terrestrial wireless access technologies, including the LTE and NR radio access technologies, for satellite networks is drawing significant interest, which has been reflected in the 3rd-Generation Partnership Project (3GPP) standardization work.

In Release 15, 3GPP started the work to prepare NR for operation in a Non-Terrestrial Network (NTN). The work was performed within the study item “NR to support Non-Terrestrial Networks” and resulted in 3GPP TR 38.811 V15.4.0. In Release 16, the work to prepare NR for operation in an NTN network continued with the study item “Solutions for NR to support Non-Terrestrial Network.”

A satellite network or satellite-based mobile network may also be called a non-terrestrial network (NTN). In contrast, a mobile network with base stations on the group may be referred to as a terrestrial network (TN) or non-NTN network. A satellite within NTN may be referred to as an NTN node, NTN satellite, satellite node or simply a satellite.

A satellite radio access network usually includes the following components:
A satellite that refers to a space-borne platform.
An earth-based gateway that connects the satellite to a base station or a core network, depending on the choice of architecture. This may be referred to as a “sat-gateway.”
A feeder link, which is the link between a gateway and a satellite.
An access link, or service link, which is the link between a satellite and a UE.

A satellite (or UAS platform) may implement either a transparent or a regenerative (with on board processing) payload. A transparent payload architecture, which may also be referred to as a “bent pipe” architecture, means that only radio-frequency filtering, frequency conversion, and amplification are performed on the signals that pass through the satellite on their way to and from the terminal equipment and network equipment on the ground. Hence, the waveform signal repeated by the payload is un-changed. When applied to general 3GPP architecture and terminology, the transparent payload architecture means that the gNB is located on the ground and the satellite forwards signals/data between the gNB and the UE.

With a regenerative payload, radio frequency filtering, frequency conversion and amplification, as well as demodulation/decoding, switch and/or routing, coding/modulation are performed by the satellite. This is effectively equivalent to having all or part of base station functions (e.g., gNB) on board the satellite (or UAS platform).

In the work item for NR NTN in 3GPP release 17, only the transparent payload architecture is considered.

Depending on the orbit altitude, a satellite may be categorized as low earth orbit (LEO), medium earth orbit (MEO), or geostationary earth orbit (GEO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

A satellite that does not operate in geostationary earth orbit is also broadly called an Non-Geostationary Orbit (NGSO) satellite. MEO satellites and LEO satellites are NGSO satellites.

There may be different types of satellites or Unmanned Aerial System (UAS) platforms in any given NTN. Example characteristics of various satellites and UAS platforms are illustrated in Table 1.

TABLE 1

| | Altitude | | Typical beam |
|---|---|---|---|
| Platforms | range | Orbit | footprint size |
| Low-Earth Orbit | 300-1500 km | Circular around the earth | 100-1000 km |
| (LEO) satellite | | | |
| Medium-Earth | 7000- | | 100-1000 km |
| Orbit (MEO) | 25000 km | | |
| satellite | | | |
| Geostationary | 35 786 km | notional station keeping | 200-3500 km |
| Earth Orbit | | position fixed in terms of | |
| (GEO) satellite | | elevation/azimuth with | |
| UAS platform | 8-50 km | respect to a given earth | 5-200 km |
| (including HAPS) | (20 km for | point | |
| | HAPS) | | |
| High Elliptical | 400- | Elliptical around the | 200-3500 km |
| Orbit (HEO) | 50000 km | earth | |
| satellite | | | |

A geosynchronous earth orbit (GEO) satellite in an NTN is fed by one or several sat-gateways which are deployed across the satellite targeted coverage (e.g., regional or even continental coverage). A non-GEO satellite in an NTN is served successively by one or several sat-gateways at a time. The system ensures service and feeder link continuity between the successive serving sat-gateways with sufficient time duration to proceed with mobility anchoring and hand-over. A wireless device, or “UE,” in a given cell is served by only one sat-gateway.

The significant orbit height means that satellite systems are characterized by a path loss that is significantly higher than what is expected in terrestrial networks. To overcome the pathloss it is often required that the access and feeder links are operated in line-of-sight conditions and that the UE is equipped with an antenna offering high beam directivity.

FIG. 1 shows an example architecture of a satellite network with bent pipe transponders. The gNB, illustrated as simply a base station (BS) in FIG. 1, may be integrated in the gateway or connected to the gateway via a terrestrial connection (wire, optic fiber, wireless link). As seen in FIG. 1, a communication satellite may generate several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The former is referred to as a moving cells (or moving beams) deployment scenario, while the latter is referred to as a quasi-earth-fixed cells (or quasi-earth-fixed beams) deployment scenario. The size of a spotbeam depends on the system design, which may range from tens of kilometers to a few thousands of kilometers.

As noted above, in the work item for NR NTN in 3GPP release 17, only the transparent payload architecture is considered, e.g., as illustrated in FIG. 2. This figure illustrates a networking-RAN architecture with a transparent satellite that effectively relays communications between a 5G base station (gNB) and the UE.

In comparison to the beams observed in a terrestrial network, an NTN beam may be very wide and cover an area outside of the area defined by the served cell. Beams covering adjacent cells will overlap and cause significant levels of intercell interference. To overcome the large levels of interference, a typical approach is for the NTN to configure different cells with different carrier frequencies and polarization modes.

In a LEO or MEO communication system, a large number of satellites deployed over a range of orbits is required to provide continuous coverage across the full globe. Launching a very large satellite constellation is both an expensive and time-consuming procedure. It is therefore expected that all LEO and MEO satellite constellations for some time will only provide partial earth-coverage. In case of some constellations dedicated to massive IoT services with relaxed latency requirements, it may not even be necessary to support full earth-coverage. It may be sufficient to provide occasional or periodic coverage according to the orbital period of the constellation.

Propagation delay is an important aspect of satellite communications that is different from the delay expected in a terrestrial mobile system. For a bent pipe satellite network, the round-trip delay may, depending on the orbit height, range from tens of milliseconds (ms) in the case of LEO satellites to several hundreds of milliseconds for GEO satellites. As a comparison, the round-trip delays in terrestrial cellular networks are typically below 1 ms.

The distance between the UE and a satellite can vary significantly, depending on the position of the satellite and thus the elevation angle & seen by the UE. Assuming circular orbits, the minimum distance is realized when the satellite is directly above the UE (ε=) 90°, and the maximum distance when the satellite is at the smallest possible elevation angle. Table 2 shows the distances between satellite and UE for different orbital heights and elevation angles together with the one-way propagation delay and the maximum propagation delay difference (the difference from the propagation delay at ε=90°). Note that this table assumes regenerative payload architecture. For the transparent payload case, the propagation delay between gateway and satellite needs to be considered as well, unless the base station corrects for that.

TABLE 2

| | | | One-way | Propagation |
|---|---|---|---|---|
| Orbital | Elevation | Distance | propagation | delay |
| height | angle | UE <-> satellite | delay | difference |
| 600 km | 90° | 600 km | 2.0 ms | — |
| | 30° | 1075 km | 3.6 ms | 1.6 ms |
| | 10° | 1932 km | 6.4 ms | 4.4 ms |
| 1200 km | 90° | 1200 km | 4.0 ms | — |
| | 30° | 1999 km | 6.7 ms | 2.7 ms |
| | 10° | 3131 km | 10.4 ms | 6.4 ms |
| 35786 km | 90° | 35786 km | 119.4 ms | — |
| | 30° | 38609 km | 128.8 ms | 9.4 ms |
| | 10° | 40581 km | 135.4 ms | 16.0 ms |

The propagation delay may also be highly variable due to the high velocity of the LEO and MEO satellites and change in the order of 10-100 μs every second, depending on the orbit altitude and satellite velocity.

In 3GPP TR 38.821, which is a technical report by 3GPP describing “Solutions for NR to Support Non-Terrestrial Networks (NTN),” it has been provided that ephemeris data should be provided to the UE, for example to assist with pointing a directional antenna (or an antenna beam) towards the satellite. A UE knowing its own position, e.g., thanks to GNSS support, may also use the ephemeris data to calculate correct timing-related parameters, such as Timing Advance (TA) and/or account for frequency drifts, e.g., Doppler shift. The contents of the ephemeris data and the procedures on how to provide and update such data have not yet been studied in detail.

A satellite orbit can be fully described using 6 parameters. Exactly which set of parameters is used can be decided by the user; many different representations are possible. For example, a choice of parameters used often in astronomy is the set (a, ε, i, Ω, ω, t). Here, the semi-major axis a and the eccentricity ε describe the shape and size of the orbit ellipse; the inclination i, the right ascension of the ascending node Ω, and the argument of periapsis ω determine its position in space, and the epoch t determines a reference time (e.g., the time when the satellites moves through periapsis). The set of these parameters is illustrated in FIG. 3.

A two-line element set (TLE) is a data format encoding a list of orbital elements of an Earth-orbiting object for a given point in time, the epoch. As an example of a different parametrization, TLEs use mean motion n and mean anomaly M instead of the semi-major axis a and the reference time t.

A completely different set of parameters is the position and velocity vector (x, y, z, vx, vy, vz) of a satellite. These are sometimes called orbital state vectors. They can be derived from the orbital elements and vice versa since the information they contain is equivalent. All these formulations (and many others) are possible choices for the format of ephemeris data to be used in NTN.

Additionally, the ephemeris data may be accompanied with information on possible coverage area, or timing information when the satellite is going to serve a certain geographical area on Earth.

To handle the timing and frequency synchronization in an NR-based or LTE-based NTN, the end-user device, or UE, is equipped with a Global Navigation Satellite System (GNSS) receiver. The GNSS receiver allows a device to estimate its geographical position. The UE can then determine the propagation delay, the delay variation, the Doppler shift and its variation rate based on its own location and the satellite's location information.

In 3GPP's Release 17 study item on NB-IoT and LTE M for NTN and the Rel-17 and Rel-18 work items on IoT NTN, simultaneous operation of NB-IoT/eMTC and GNSS is not assumed.

The background to this 3GPP assumption is that a cellular device may share parts of its RF architecture between the cellular modem and the GNSS chip. A basic solution is to make use of the same antenna for receiving the GNSS reference signal, and for receiving and transmitting an LTE or NR signal. A switch determines if the antenna should be connected to the cellular RF frontend or the GNSS RF frontend. The switch provides the needed isolation between the cellular transmitter and the GNSS receiver, but does also prevent simultaneous GNSS and cellular operation.

A 3GPP device in RRC_IDLE or RRC_INACTIVE state is required to perform number of procedures including measurements for mobility purposes, paging monitoring, logging measurement results, tracking area update, and search for a new PLMN to mention a few. These procedures will consume power in devices, and a general trend in 3GPP has been to allow for relaxation of these procedures to prolong device battery life. This trend has been especially pronounced for IoT devices supported by reduced capability (redcap), NB IoT and LTE M.

In 3GPP TR 36.763, which documents a “Study on Narrow-Band Internet of Things (IoT)/enhanced Machine Type Communication (eMTC) Support for Non-Terrestrial Networks (NTN),” the impact of GNSS position fix on the battery life of an IoT NTN UE is described. In addition several aspects related to GNSS operation e.g. GNSS measurement gaps were also studied and documented in this report.

3GPP has made several agreements related to GNSS enhancements in 3GPP RAN1 meetings during the Rel-17 IoT NTN Work Item (WI). In this WI, a GNSS validity duration parameter was introduced. Upon GNSS acquisition, a UE will autonomously determine its GNSS validity duration from the agreed set of values and report it to the network. Upon expiry of GNSS validity duration during RRC_CONNECTED state, a UE is expected to return to idle mode to refresh its GNSS position, because GNSS acquisition during connected mode is not supported/required by existing standards. The relevant agreements include:

### Agreement:

For sporadic short transmission, UE in RRC_CONNECTED should go back to idle mode and re-acquire a GNSS position fix if GNSS becomes outdated.

### Agreement:

The UE autonomously determines its GNSS validity duration X and reports information associated with this valid duration to the network via RRC signalling.
   X={10 s, 20 s, 30 s, 40 s, 50 s, 60 s, 5 min, 10 min, 15 min, 20 min, 25 min, 30 min, 60 min, 90 min, 120 min, infinity}

In the Rel-18 IoT NTN WI, the focus is on long connections where the GNSS expires during the connected mode. Instead of following the default Rel-17 procedure where a UE in RRC_CONNECTED mode returns to RRC_IDLE mode upon GNSS expiry, an enhanced UE behavior is under discussion where the UE is allowed to reacquire its GNSS position fix during the RRC_CONNECTED state. Moreover, another goal is to reduce the number of GNSS position fixes that a UE may need during RRC_CONNECTED mode in order to reduce UE power consumption.

Agreements in the Rel-18 IoT NTN WI relating to closed-loop time and frequency correction include:

### Agreement

Closed loop time and frequency correction, with potential enhancements, for IoT-NTN is considered to reduce the need for UE to update GNSS position fix in long connection time.

### Agreement

At least for the case when frequency error is within frequency error requirements, study the mechanisms and conditions to allow UL transmission after original GNSS validity duration expires without GNSS re-acquisition for some duration.
   FFS: with legacy closed loop time correction or enhanced closed loop time correction
   This mechanism is enabled/configured by eNB
FFS: whether such mechanism will be specified depends on the outcome of this study

Agreements relating to GNSS position fix in RRC_Connected state include:

### Agreement

At least the following options can be considered on GNSS measurement in connected for potential enhancements for improved GNSS operations:
   Option 1: UE re-acquires GNSS position fix during RLF procedure
   Option 2: UE re-acquires GNSS position fix with a new gap
Note: this does not imply that a Rel-18 IoT NTN UE is mandated to support one or both of the options.

### Agreement

Further study on whether there is a need for potential enhancements on the following for long connection time
   UE triggered GNSS measurement.
   Network triggered GNSS measurement.

### Agreement

Support eNB to at least aperiodically trigger UE to make GNSS measurement.

### Agreement

If eNB aperiodically triggers UE to make GNSS measurement, a MAC CE is used.

### Agreement

For GNSS measurement in RRC connected, if eNB aperiodically triggers connected UE to make GNSS measurement, UE can re-acquire GNSS position fix with a gap
   FFS details of gap configuration

### Agreement

The UE may re-acquire GNSS autonomously (when configured by the network) if UE does not receive eNB trigger to make GNSS measurement
   FFS based on configured timing

### Agreement

On when the GNSS measurement gap starts, which is aperiodically triggered by eNB with MAC CE, RAN1 can down select one of the following alternatives:
Alt 1: the start time should be at n+X, where n is the end of MAC CE receiving subframe/slot
   FFS: details of X, e.g. predefined value or configured value
Alt 2: the start time should be based on the current GNSS validity duration with delay or without delay

### Agreement

On the length of GNSS measurement gap, which is aperiodically triggered by eNB, the gap duration should be equal to or larger than the latest UE reported GNSS position fix time duration.
FFS: whether the gap duration is configured by eNB, or the gap duration is equal to the latest reported GNSS position fix time duration.

Agreements relating to GNSS assistance information include:

### Agreement

GNSS assistance information that UE reports to eNB at least consists of:
   GNSS position fix time duration for measurement
   GNSS validity duration

### Agreement

When eNB triggers UE to make GNSS measurements, UE re-acquires GNSS position fix.
   FFS details of signalling
   FFS how UE reports GNSS assistance information after eNB trigger and the detailed content
   Note: further discuss whether a UE is expected to handle all eNB triggers

### Agreement

UE reports GNSS position fix time duration for measurement at least during the initial access stage.
which message carries this information is up to RAN2

### Agreement

In connected mode, UE may report GNSS validation duration with MAC CE.

### Agreement

UE reports only one GNSS position fix time duration for GNSS measurement at least when moving to RRC connected state.

### Agreement

The following alternatives can be considered to inform eNB the success of GNSS measurement at UE side after GNSS measurement in RRC connected.
   Alt-1: The UE will report the new GNSS validity duration
   Alt-2: The reception of any UL transmission from the UE at eNB after the GNSS measurement

### SUMMARY

In the 3GPP Release 18 IoT NTN WI, RAN1 has agreed to aperiodically trigger an IoT NTN UE to perform a GNSS measurement using a GNSS measurement gap using a MAC CE. However, the details of the measurement gap and the UE behavior are yet to be designed.

RAN1 has also agreed that the UE will report GNSS assistance information to the network, but the detailed design has not been specified.

The description of various embodiments provided herein include details on how to trigger GNSS measurements of different types for an IoT NTN UE. Details of UE behavior upon receiving a GNSS measurement trigger are also described, as are methods for reporting validity duration for GNSS assistance information and for configuring UE behavior for reporting GNSS assistance information.

Embodiments described herein include, for example, a method, in a UE, for performing GNSS measurements, where the method comprises receiving an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements. The method further comprises performing one or more GNSS measurements in accordance with the indication.

Embodiments described herein also include corresponding methods carried out in a network node, for facilitating GNSS measurements by a UE. An example method, in a network node, comprises the step of sending, to the UE, an indication of a selection of a type of GNSS measurement to be performed by the UE from among at least two of: an aperiodic GNSS measurement, an event-based GNSS measurement, a time-periodic GNSS measurement, and a periodic GNSS measurement, where ‘periodic GNSS measurement’ encompasses both time-periodic GNSS measurements and event-based GNSS measurements. The example method further comprises the steps of receiving, from the UE, GNSS assistance information, and receiving from the UE, with or in association with the GNSS assistance information, information indicating a validity duration corresponding to all or part of the GNSS assistance information.

Apparatuses and systems adapted to/configured to carry out some or all of the methods summarized above, and variants thereof, are also described in detail below.

Using various embodiments of the techniques, apparatuses, and systems described herein allows a network to configure a UE with potentially different types of GNSS measurement gaps as well as the UE behavior for GNSS reacquisition. Some embodiments allow the UE to report validity duration of GNSS assistance information reported by the UE to eNB and/or allow the eNB to configure UE behavior for reporting GNSS assistance information.

### BRIEF DESCRIPTION OF THE FIGURES

FIG. 1 shows an example architecture of a satellite network with bent pipe transponders.

FIG. 2 illustrates the so-called transparent payload architecture for an NTN and its integration with the 5G network.

FIG. 3 illustrates various parameters for describing a satellite orbit.

FIG. 4, FIG. 5, and FIG. 6 each illustrate an example method as carried out by a UE, according to some embodiments.

FIG. 7 is a process flow diagram illustrating an example method carried out by a network node, according to some embodiments.

FIG. 8 shows an example communication system, according to some embodiments.

FIG. 9 illustrates components of an example UE, according to some embodiments.

FIG. 10 illustrates components of an example network node, according to some embodiments.

FIG. 11 illustrates an example virtualization environment.

### DETAILED DESCRIPTION

Some of the embodiments contemplated herein will now be described more fully with reference to the accompanying drawings. Embodiments are provided by way of example to convey the scope of the subject matter to those skilled in the art.

While the embodiments outlined below are described mainly in terms of LTE-based (including IoT) NTNs, they are equally applicable in an NTN based on NR (including IoT) technology. The term “network” is used as an adjective in the solution description below to refer to a network node, which typically will be an eNB (e.g. in a LTE-based NTN such as IoT NTN), but which may also be a gNB (e.g. in a NR-based NTN), or a base station or an access point in another type of network, or any other network node with the ability to directly or indirectly communicate with a UE.

Global Navigation Satellite Systems (GNSS) have an important role to play in the proposed solutions. The most well-known is the American Global Positioning System (GPS), but there are also other also other similar systems that could provide the functionality utilized in the proposed solution, e.g., the Russian Global Navigation Satellite System (GLONASS), the Chinese BeiDou Navigation Satellite System and the European Galileo.

The terms “connected mode,” “RRC_CONNECTED state,” or “RRC_CONNECTED mode” are used interchangeably in this document and refer to a state in which the end user terminal, or UE, maintains a connection with the network, such that data can be readily exchanged between the terminal. This does not imply that there are continuous transmissions in either direction, but instead that a connection and information defining the connection are being controlled by the network and that resources are readily available for exchange of end-user data through the connection.

The following discussion uses the terms aperiodic, event-based, and time-periodic GNSS measurement events. A time-periodic GNSS measurement event means that the UE performs GNSS measurements in a time-periodic manner according to a GNSS measurement command and the configuration sent in that command. An event-based GNSS measurement means that the UE performs one or more measurements according to a GNSS measurement command and the configuration sent in that command such that the occurrence of those measurements is tied to an event (e.g., the expiry of GNSS validity duration with or without a certain time offset). Note that the term periodic by itself, as used herein, refers to the time-periodic GNSS measurements as well as the event-based GNSS measurements. If further distinction between these two types is intended, the terms “time-periodic” measurement and “event-based” GNSS measurement are used.

The symbols M₁, M₂, M₃, . . . , Mₙ, . . . are used herein to refer to the first, second, third, and n^{th} GNSS measurement that a UE performs in RRC_CONNECTED state.

When a signaling message or parameter, or a UE behavior, is specified in a standard, this is in this document referred to as “standardized,” “specified,” or “specified in a standard”. That is, these expressions/terms are equivalent.

The term/expression “GNSS position fix time duration” refers to the time the UE needs to perform a GNSS position fix (i.e., a successful GNSS position measurement), which may vary, e.g., depending on the UE's GNSS state (often referred to as “hot,” “warm,” and “cold” states, or “hot start,” “warm start,” and “cold start”).

In the 3GPP Release 18 IoT NTN WI, RAN1 has agreed that the standards will allow the network to aperiodically trigger an IoT NTN UE to perform a GNSS measurement using a GNSS measurement gap, with the triggering using a Medium Access Control Control Element (MAC CE) sent by the network to the UE. However, the details of the measurement gap and the UE behavior in response to the MAC CE have not previously been defined.

In some embodiments according to the presently disclosed techniques, an X-bit indicator is included in the MAC CE triggering GNSS measurement to indicate one or more (or any combination) of the following information:
Whether the GNSS measurement to be performed is:
   aperiodic, event-based, or time-periodic (as one embodiment variant),
   aperiodic or event-based (as another embodiment variant),
   event-based or time-periodic (as another embodiment variant).
Whether the GNSS measurement gap duration is set to the closest value greater than or equal to the UE reported value for the GNSS position fix time duration, or to the value indicated by the eNB
Whether the UE needs to report its GNSS position fix time duration after performing the next GNSS measurement
Whether the UE needs to report its GNSS position fix time duration every time it performs a GNSS measurement
Whether the UE needs to report one, two or three values for the GNSS position fix time duration
Whether the UE needs to report more than one value for the GNSS position fix time duration
The number of GNSS measurements for which the measurement configuration is valid
The time period during which the GNSS measurement gap configuration is valid

As one example, a 1-bit flag may be included in the MAC CE used for triggering GNSS measurement to indicate whether the measurement configuration is periodic (i.e., event-based or time-periodic) or aperiodic. If the flag is set to 1, the UE will re-use the same GNSS configuration for its next GNSS measurement, i.e., it will use the same GNSS measurement gap duration and the trigger time (i.e., a periodically recurring trigger time) for the GNSS measurement gap for its subsequent GNSS measurements.

In other embodiments, separate GNSS measurement commands are used for triggering aperiodic GNSS measurements, time-periodic GNSS measurements, and event-based GNSS measurements.

In other embodiments, an X-bit indicator is included in the RRC message triggering GNSS measurement to indicate one or more (or any combination) of the information mentioned in the previous embodiment based on MAC CE.

In other embodiments, the aforementioned X-bit indicator is indicated separately, i.e., not in the MAC or RRC message triggering GNSS measurement. In yet another embodiment, one or more bits of the X-bit indicator are indicated using the MAC or RRC message triggering the GNSS measurement, while remaining one or more bits (if any) are indicated separately using MAC, DCI, or RRC signalling.

This X-bit indicator can be a bit map in the MAC CE or RRC, e.g., one bit to indicate aperiodic, one bit to indicate event-based and one bit to indicate time-periodic measurements, or codepoints where each codepoint refers to certain measurement configuration or a combination of measurement configuration.

### UE Behavior Upon Receiving GNSS Measurement Trigger:

If an aperiodic GNSS measurement trigger was received by the UE to perform GNSS measurement M₁, and the GNSS measurement configuration was indicated to be periodic,
If the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂.
If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂. Here, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following the GNSS validity duration expiry where X can be either fixed in the specification (e.g., X=0 or X=1 ms) or configured by the network.

If an aperiodic GNSS measurement trigger was received by the UE to perform GNSS measurement M₁, and the GNSS measurement configuration was indicated to be aperiodic, the UE applies the configuration only for the measurement M₁.

If a new GNSS measurement trigger is received, the UE will discard the instruction received in the previous GNSS measurement trigger.

If a new GNSS measurement trigger is received and the network indicates the one or more measurement gaps for which this trigger will be valid and/or the time duration for which the GNSS measurement trigger will be applicable, the UE will discard the instructions received in the previous GNSS measurement trigger and apply the new instructions only for the GNSS measurement gaps indicated in the new GNSS measurement trigger and/or for the time duration during (or after) which the GNSS measurement trigger will be activated, e.g., it may apply the GNSS measurement received in the second-last GNSS measurement trigger until the GNSS measurement trigger activation time of the latest GNSS measurement trigger is reached.

One or more combinations of the above methods can be used.

### GNSS Assistance Information Validity and Reporting

In some embodiments, the UE includes the validity duration of the GNSS assistance information that it reports to the eNB. In some embodiments, a single value can be used for all the parameters reported as part of the GNSS assistance information. Alternatively, a separate validity duration can be reported for each parameter value reported as part of the GNSS assistance information. As yet another alternative, one or more validity durations can be reported for the GNSS assistance information where one validity duration is applicable to one or more parameter values reported as part of the GNSS assistance information. In another embodiment, the validity durations are also reported as part of the GNSS assistance information.

For example, if the UE reports GNSS position fix time duration as part of the assistance information, it also includes how long this value can be considered valid by the network.

In some embodiments, after having reported the GNSS position fix time duration a first time upon entering RRC_CONNECTED state, the UE reports the GNSS position fix time duration only when it has changed since the last time the UE reported it.

In some embodiments, the eNB configures the UE's behavior with regards to reporting of the GNSS position fix time duration. For instance, the eNB could configure the UE to:
report the GNSS position fix time duration only upon entering RRC_CONNECTED state,
report the GNSS position fix time duration after every new GNSS measurement,
report the GNSS position fix time duration when it reports the GNSS validity duration (i.e. together with the GNSS validity duration),
report the GNSS position fix time duration upon entering RRC_CONNECTED state and then when it has changed since the last time the UE reported it,
report the GNSS position fix time duration upon entering RRC_CONNECTED state and then after every new GNSS measurement if the GNSS position fix time duration has changed since the last time the UE reported it,
report the GNSS position fix time duration upon entering RRC_CONNECTED state and then together with the reports of the GNSS validity duration if the GNSS position fix time duration has changed since the last time the UE reported it.

In other embodiments, similar behavior can be defined for other types (i.e., other than GNSS position fix duration and GNSS validity duration) of GNSS assistance information.

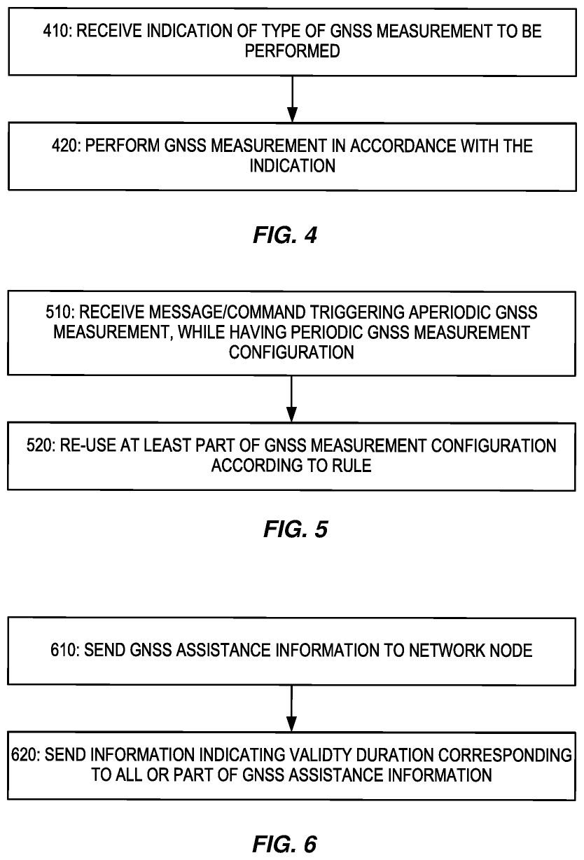

In view of the detailed examples and explanations provided above, it will be appreciated that FIG. 4, FIG. 5, and FIG. 6 are process flow diagrams that illustrate generalized methods, as carried out by a UE, for performing GNSS measurements. The methods illustrated in these figures are intended to be generalizations of various ones of the techniques described above, from the perspective of a UE, such as a UE operating in an NTN. Thus, where the terminology used in these figures and in the description below differs from similar or clearly related terminology used above, the terminology in the figures and below should be understood as at least encompassing the terminology used to describe specific examples above. Note that while these figures illustrate three distinct methods, a given UE might be configured to perform any one, some, or all of the methods.

Referring first to FIG. 4, the illustrated method includes, as shown at block 410, the step of receiving an indication of a selection of a type of GNSS measurement to be performed by the UE. Various approaches to how this indication works were provided above. In some examples, the indication may be received in or associated with a command configuring a GNSS measurement for the UE. The indication may, in various embodiments, be configured to select a type of GNSS measurement from among at least two of the following types: an aperiodic GNSS measurement, an event-based GNSS measurement, a time-periodic GNSS measurement, and a periodic GNSS measurement, where ‘periodic GNSS measurement’ encompasses both time-periodic GNSS measurements and event-based GNSS measurements.

As shown at block 420, the method further comprises performing one or more GNSS measurements in accordance with the indication.

In some embodiments or instances, the indication indicates whether the GNSS measurement to be performed by the UE is an aperiodic GNSS measurement or an event-based GNSS measurement. In other embodiments or instances, the indication indicates whether the GNSS measurement to be performed by the UE is an event-based GNSS measurement or a time-periodic measurement. In still others, the indication indicates whether the GNSS measurement to be performed by the UE is an aperiodic measurement or a periodic measurement, where a periodic measurement is either a time-periodic measurement or an event-based measurement.

The indication may be a 1-bit flag in some embodiments or instances, e.g., where the indication selects one of two types of GNSS measurements. In some embodiments or instances, the indication is instead a multi-bit indicator, the setting of bits in the multi-bit indicator indicating the types of GNSS measurement to be performed by the UE. This may be via a bit-map, for example, where each bit in the indicator corresponds to a type of GNSS. Alternatively, each of several possible settings of the multi-bit indicator may be a codepoint that maps to a predefined GNSS measurement type and/or GNSS measurement configuration.

In various embodiments or instances, the indication is included in a MAC CE or RRC message triggering GNSS measurement. In others, the indication may be sent separately from a MAC CE or RRC message triggering GNSS measurement.

In some embodiments or instances, the method may further comprise receiving, with or in association with the indication, one or more of any of the following: an indication of a GNSS measurement gap for performing the GNSS measurement(s); an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node; an indication of whether the UE is to report its GNSS position fix time duration after performing a next GNSS measurement; an indication of whether the UE is to report its GNSS position fix time duration every time it performs a GNSS measurement; an indication of whether the UE needs to report one, two, or three values for the GNSS position fix time duration; an indication of whether the UE needs to report more than one value for the GNSS position fix time duration; a number of GNSS measurements for which a measurement configuration provided to the UE is valid; and a time period during which a GNSS measurement gap configuration provided to the UE is valid.

FIG. 5 illustrates another example method as might be implemented in a UE For performing GNSS measurements. As noted above, this method may be performed in conjunction with the method shown in FIG. 4, in some embodiments or instances.

The method shown in FIG. 5 includes, as shown at block 510, the step of receiving a message or command triggering an aperiodic GNSS measurement M₁, the UE having been provided with a GNSS measurement configuration indicated to be periodic. The method further comprises, as shown at block 520, re-using at least part of the GNSS measurement configuration according to a certain rule. This rule may be as follows:
if the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂, and
If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂, where, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following GNSS validity duration expiry, where X can be either fixed in the specification (e.g., X=0 or X=1 ms) or configured by the network.

FIG. 6 illustrates still another example method as might be implemented in a UE For performing GNSS measurements. As noted above, this method may be performed in conjunction with either or both of the methods shown in FIG. 4 and FIG. 5, in some embodiments or instances.

As shown at block 610, this method includes the step of sending, to a network node, GNSS assistance information. As shown at block 620, the method further comprises sending, with or in association with the GNSS assistance information, information indicating a validity duration corresponding to all or part of the GNSS assistance information. In some embodiments or instances, the information indicating a validity duration comprises an indication of a GNSS position fix time duration reported by the UE to the network node. Discussion above included detailed descriptions of various examples and variations of how this validity duration information might be conveyed, and when.

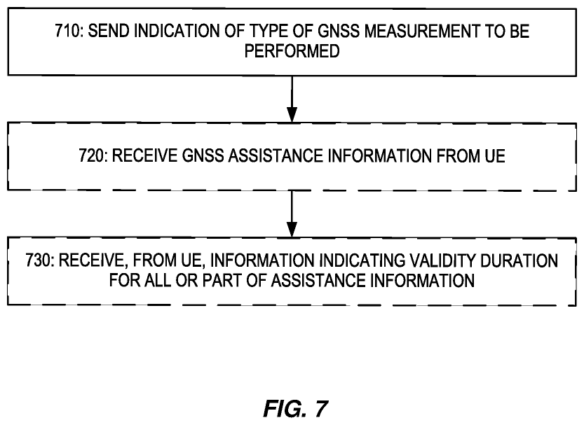

FIG. 7 is a process flow diagram that illustrates a generalized method, as carried out by a network node, for facilitating the performing of GNSS measurements by a UE. Thus, this method complements those described above. Again, the method illustrated in this figure is intended to be a generalization of various techniques described above, from the perspective of a network node, such as a gNB or eNB operating in an NTN. Thus, where the terminology used in these figures and in the description below differs from similar or clearly related terminology used above, the terminology in the figures and below should be understood as at least encompassing the terminology used to describe specific examples above.

The method shown in FIG. 7 includes, as shown at block 710, the step of sending, to the UE, an indication of a selection of a type of GNSS measurement to be performed by the UE. Various approaches to how this indication works were provided above. In some examples this may be in or associated with a command configuring a GNSS measurement for the UE. The indication may, in various embodiments, be configured to select a type of GNSS measurement from among at least two of the following types: an aperiodic GNSS measurement, an event-based GNSS measurement, a time-periodic GNSS measurement, and a periodic GNSS measurement, where ‘periodic GNSS measurement’ encompasses both time-periodic GNSS measurements and event-based GNSS measurements.

As was the case with the corresponding method shown in FIG. 4, in some embodiments or instances, this indication indicates whether the GNSS measurement to be performed by the UE is an aperiodic GNSS measurement or an event-based GNSS measurement. In other embodiments or instances, the indication indicates whether the GNSS measurement to be performed by the UE is an event-based GNSS measurement or a time-periodic measurement. In still others, the indication indicates whether the GNSS measurement to be performed by the UE is an aperiodic measurement or a periodic measurement, where a periodic measurement is either a time-periodic measurement or an event-based measurement.

The indication may be a 1-bit flag in some embodiments or instances, e.g., where the indication selects one of two types of GNSS measurements. In some embodiments or instances, the indication is instead a multi-bit indicator, the setting of bits in the multi-bit indicator indicating the types of GNSS measurement to be performed by the UE. This may be via a bit-map, for example, where each bit in the indicator corresponds to a type of GNSS. Alternatively, each of several possible settings of the multi-bit indicator may be a codepoint that maps to a predefined GNSS measurement type and/or GNSS measurement configuration.

In various embodiments or instances, the indication is included in a MAC CE or RRC message triggering GNSS measurement. In others, the indication may be sent separately from a MAC CE or RRC message triggering GNSS measurement.

In some embodiments or instances, the method may further comprise sending, with or in association with the indication, one or more of any of the following: an indication of a GNSS measurement gap for performing the GNSS measurement(s); an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node; an indication of whether the UE is to report its GNSS position fix time duration after performing a next GNSS measurement; an indication of whether the UE is to report its GNSS position fix time duration every time it performs a GNSS measurement; an indication of whether the UE needs to report one, two, or three values for the GNSS position fix time duration; an indication of whether the UE needs to report more than one value for the GNSS position fix time duration; a number of GNSS measurements for which a measurement configuration provided to the UE is valid; and a time period during which a GNSS measurement gap configuration provided to the UE is valid.

In some embodiments or instances of the method shown in FIG. 7, the method further comprises, as shown at block 720, the step of receiving GNSS assistance information. In these embodiments or instances, the method may still further comprise receiving from the UE, with or in association with the GNSS assistance information, information indicating a validity duration corresponding to all or part of the GNSS assistance information. This is shown at block 730. Once again, the discussion above includes detailed descriptions of various examples and variations of how this validity duration information might be conveyed, and when.

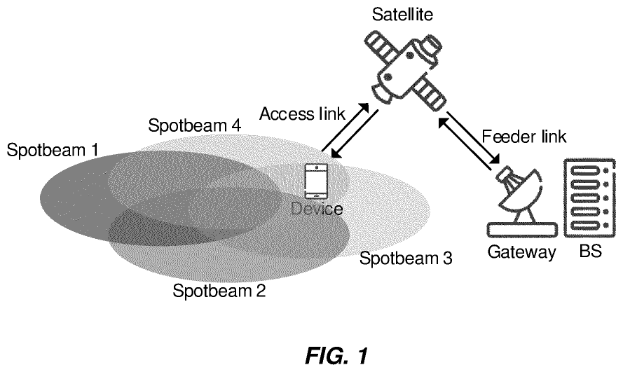

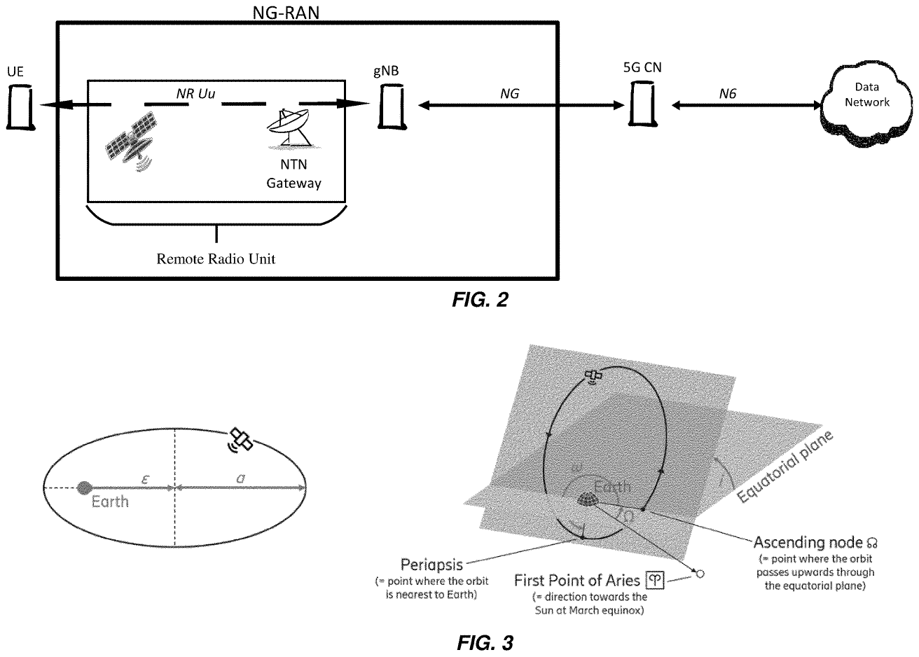

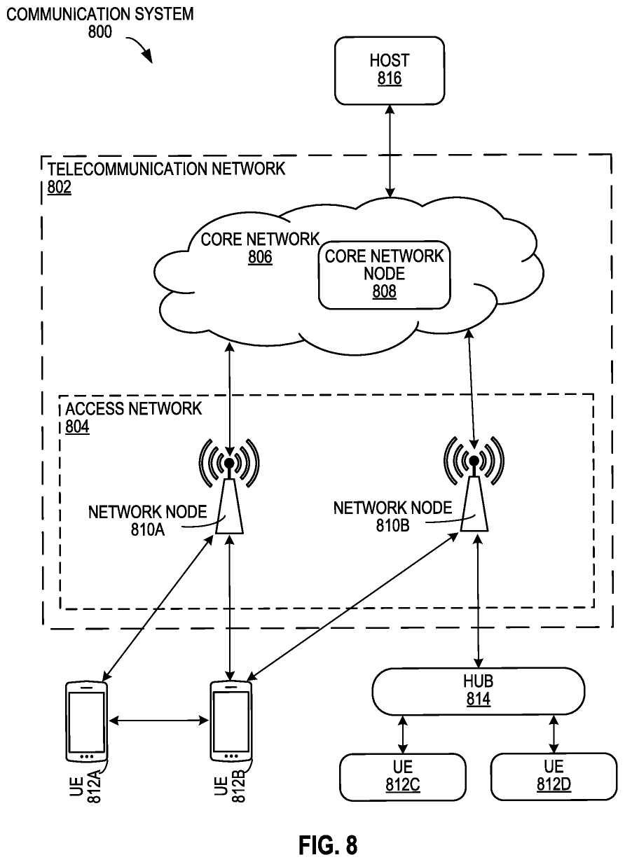

FIG. 8 shows an example of a communication system 800 in accordance with some embodiments. Not shown here is an NTN node and the feeder link from an eNB or gNB to an NTN node, by way of which the system communicates with a UE via an NTN node—this is shown in FIG. 1. This example system provides a general context for the techniques described above. Some of the described details or variants may not be applicable to an NTN system or other network deployment in which the techniques described are implemented.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 802 includes one or more Open-RAN (ORAN) network nodes. An ORAN network node is a node in the telecommunication network 802 that supports an ORAN specification (e.g., a specification published by the O-RAN Alliance, or any similar organization) and may operate alone or together with other nodes to implement one or more functionalities of any node in the telecommunication network 802, including one or more network nodes 810 and/or core network nodes 808.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

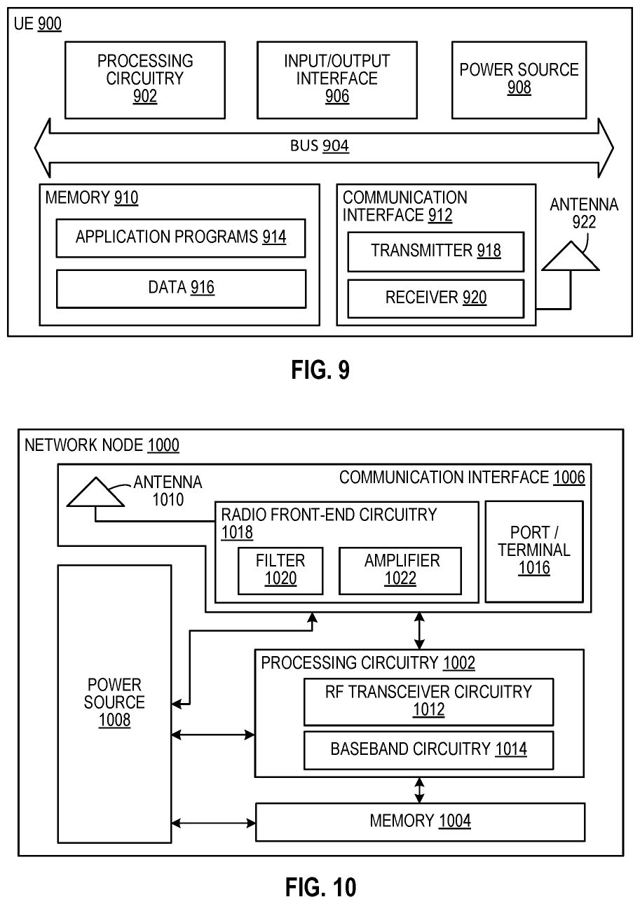

FIG. 9 shows a UE 900 in accordance with some embodiments. Several of the methods described above may be implemented in some of these embodiments. However, some of the details or variants described here may not be applicable to, for example, an NTN. As used herein, a UE refers to a device capable, configured, arranged and/or operable to communicate wirelessly with network nodes and/or other UEs. In some embodiments, the UE is configured, arranged, and/or operable to communicate wirelessly with an NTN, e.g., through an NTN node to a gNB, as in FIG. 1. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In the illustrated embodiment, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. Several of the techniques described herein in relation to network nodes, base stations, or the like may be implemented in a network node 1000 having some or all of these features. However, some of the details or variants may be inapplicable or unnecessary to, for example, a gNB in an NTN deployment utilizing the techniques described herein.

As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes a processing circuitry 1002, a memory 1004, a communication interface 1006, and a power source 1008. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, to provide network node 1000 functionality.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

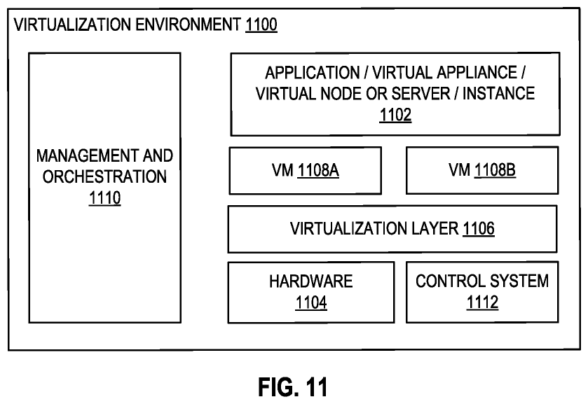

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

Embodiments of the techniques, apparatuses, and systems described herein include, but are not limited to, the following enumerated examples:

1. A method, in a user equipment, UE, for performing Global Navigation Satellite System, GNSS, measurements, the method comprising: receiving, in or associated with a command configuring a GNSS measurement for the UE, an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements; and performing one or more GNSS measurements in accordance with the indication.

2. The method of example embodiment 1, wherein the indication indicates whether the GNSS measurement to be performed by the UE is an aperiodic GNSS measurement or an event-based GNSS measurement.

3. The method of example embodiment 1, wherein the indication indicates whether the GNSS measurement to be performed by the UE is an event-based GNSS measurement or a time-periodic measurement.

4. The method of example embodiment 1, wherein the indication indicates whether the GNSS measurement to be performed by the UE is an aperiodic measurement or a periodic measurement, wherein a periodic measurement is either a time-periodic measurement or an event-based measurement.

5. The method of any one of example embodiments 1-4, wherein the indication is a 1-bit flag.

6. The method of any one of example embodiments 1-4, wherein the indication is a multi-bit indicator, the setting of bits in the multi-bit indicator indicating the types of GNSS measurement to be performed by the UE.

7. The method of any one of example embodiments 1-6, wherein the indication is included in a MAC CE or RRC message triggering GNSS measurement.

8. The method of any one of example embodiments 1-6, wherein the indication is sent separately from a MAC CE or RRC message triggering GNSS measurement.

9. The method of any one of example embodiments 1-8, wherein the method further comprises receiving, with or in association with the indication, one or more of any of the following: an indication of a GNSS measurement gap for performing the GNSS measurement(s); an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node; an indication of whether the UE is to report its GNSS position fix time duration after performing a next GNSS measurement; an indication of whether the UE is to report its GNSS position fix time duration every time it performs a GNSS measurement; an indication of whether the UE needs to report one, two, or three values for the GNSS position fix time duration; an indication of whether the UE needs to report more than one value for the GNSS position fix time duration; a number of GNSS measurements for which a measurement configuration provided to the UE is valid; and a time period during which a GNSS measurement gap configuration provided to the UE is valid.

10. The method of any of example embodiments 1-9, further comprising: receiving a message or command triggering an aperiodic GNSS measurement M₁, the UE having been provided with a GNSS measurement configuration indicated to be periodic; and re-using at least part of the GNSS measurement configuration according to the rule: if the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂, and If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂, where, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following GNSS validity duration expiry, where X can be either fixed in the specification (e.g., X=0 or X=1 ms) or configured by the network.

11. The method of any one of example embodiments 1-10, the method further comprising: sending, to a network node, GNSS assistance information; and sending, with or in association with the GNSS assistance information, information indicating a validity duration corresponding to all or part of the GNSS assistance information.

12. A method, in a user equipment, UE, for performing Global Navigation Satellite System, GNSS, measurements, the method comprising: receiving a message or command triggering an aperiodic GNSS measurement M₁, the UE having been provided with a GNSS measurement configuration indicated to be periodic; and re-using at least part of the GNSS measurement configuration according to the rule: if the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂, and If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂, where, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following GNSS validity duration expiry, where X can be either fixed in the specification (e.g., X=0 or X=1 ms) or configured by the network.

13. A method, in a user equipment, UE, for performing Global Navigation Satellite System, GNSS, measurements, the method comprising: sending, to a network node, GNSS assistance information; and sending, with or in association with the GNSS assistance information, information indicating a validity duration corresponding to all or part of the GNSS assistance information.

14. The method of example embodiment 13, wherein the information indicating a validity duration comprises an indication of a GNSS position fix time duration reported by the UE to the network node.

15. A method, in a network node, for facilitating Global Navigation Satellite System, GNSS, measurements by a user equipment, UE, the method comprising: sending, in or associated with a command configuring a GNSS measurement for the UE, an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements.

16. The method of example embodiment 15, wherein the indication indicates whether the GNSS measurement to be performed by the UE is an aperiodic GNSS measurement or an event-based GNSS measurement.

17. The method of example embodiment 15, wherein the indication indicates whether the GNSS measurement to be performed by the UE is an event-based GNSS measurement or a time-periodic measurement.

18. The method of example embodiment 15, wherein the indication indicates whether the GNSS measurement to be performed by the UE is an aperiodic measurement or a periodic measurement, wherein a periodic measurement is either a time-periodic measurement or an event-based measurement.

19. The method of any one of example embodiments 15-18, wherein the indication is a 1-bit flag.

20. The method of any one of example embodiments 15-18, wherein the indication is a multi-bit indicator, the setting of bits in the multi-bit indicator indicating the types of GNSS measurement to be performed by the UE.

21. The method of any one of example embodiments 15-20, wherein the indication is included in a MAC CE or RRC message triggering GNSS measurement.

22. The method of any one of example embodiments 15-21, wherein the indication is sent separately from a MAC CE or RRC message triggering GNSS measurement.

23. The method of any one of example embodiments 15-22, wherein the method further comprises sending to the UE, with or in association with the indication, one or more of any of the following: an indication of a GNSS measurement gap for performing the GNSS measurement(s); an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node; an indication of whether the UE is to report its GNSS position fix time duration after performing a next GNSS measurement; an indication of whether the UE is to report its GNSS position fix time duration every time it performs a GNSS measurement; an indication of whether the UE needs to report one, two, or three values for the GNSS position fix time duration; an indication of whether the UE needs to report more than one value for the GNSS position fix time duration; a number of GNSS measurements for which a measurement configuration provided to the UE is valid; and a time period during which a GNSS measurement gap configuration provided to the UE is valid.

24. The method of any one of example embodiments 15-23, further comprising: receiving, from the UE, GNSS assistance information; and receiving from the UE, with or in association with the GNSS assistance information, information indicating a validity duration corresponding to all or part of the GNSS assistance information.

25. A user equipment for adjusting timing with respect to a serving cell in a wireless network, comprising: processing circuitry configured to perform any of example embodiments 1-14; and power supply circuitry configured to supply power to the processing circuitry.

26. A network node for assisting a user equipment, UE, to adjust timing with respect to a serving cell in a wireless network, the network node comprising: processing circuitry configured to perform any of example embodiments 15-24; power supply circuitry configured to supply power to the processing circuitry.

27. A user equipment (UE) for adjusting timing with respect to a serving cell in a wireless network, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of example embodiments 1-14; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

1-30. (canceled)

31. A method, in a user equipment (UE) for performing Global Navigation Satellite System (GNSS) measurements, the method comprising:
receiving an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements wherein the indication is included in a Medium Access Control Control Element (MAC CE); and
performing one or more GNSS measurements in accordance with the indication.

32. The method of claim 31, further comprising:
receiving a configuration for the UE to report the GNSS position fix time duration; and
reporting the GNSS position fix time duration upon entering RRC_CONNECTED state.

33. The method of claim 31, wherein the method further comprises receiving, with or in association with the indication, one or more of any of the following:
an indication of a GNSS measurement gap for performing the GNSS measurement(s);
an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node;
an indication of whether the UE is to report its GNSS position fix time duration after performing a next GNSS measurement;
an indication of whether the UE is to report its GNSS position fix time duration every time it performs a GNSS measurement;
an indication of whether the UE needs to report one, two, or three values for the GNSS position fix time duration;
an indication of whether the UE needs to report more than one value for the GNSS position fix time duration;
a number of GNSS measurements for which a measurement configuration provided to the UE is valid; and
a time period during which a GNSS measurement gap configuration provided to the UE is valid.

34. The method of claim 31, further comprising:
receiving a message or command triggering an aperiodic GNSS measurement M₁, the UE having been provided with a GNSS measurement configuration indicated to be periodic; and
re-using at least part of the GNSS measurement configuration according to the rule:
if the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂, and
If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂, where, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following GNSS validity duration expiry, where X can be either fixed in the specification or configured by the network.

35. The method of claim 31, the method further comprising:
sending, to a network node, GNSS assistance information; and
sending, with or in association with the GNSS assistance information, information indicating a validity duration corresponding to all or part of the GNSS assistance information.

36. A method, in a network node, for facilitating Global Navigation Satellite System (GNSS) measurements by a user equipment (UE), the method comprising:
sending, to the UE, an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements, wherein the indication is included in a Medium Access Control Control Element (MAC CE);
receiving, from the UE, GNSS assistance information; and
receiving from the UE, with or in association with the GNSS assistance information, information indicating a validity duration corresponding to all or part of the GNSS assistance information.

37. The method of claim 36, wherein the method further comprises sending to the UE, with or in association with the indication, one or more of any of the following:
an indication of a GNSS measurement gap for performing the GNSS measurement(s);
an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node;
an indication of whether the UE is to report its GNSS position fix time duration after performing a next GNSS measurement;
an indication of whether the UE is to report its GNSS position fix time duration every time it performs a GNSS measurement;
an indication of whether the UE needs to report one, two, or three values for the GNSS position fix time duration;
an indication of whether the UE needs to report more than one value for the GNSS position fix time duration;
a number of GNSS measurements for which a measurement configuration provided to the UE is valid; and
a time period during which a GNSS measurement gap configuration provided to the UE is valid.

38. The method of claim 36, further comprising:
sending a configuration for the UE to report the GNSS position fix time duration; and
receiving the GNSS position fix time duration upon entering RRC_CONNECTED state.

39. A user equipment (UE) for performing Global Navigation Satellite System (GNSS) measurements, the UE comprising:
an antenna configured to send and receive wireless signals;
radio front-end circuitry connected to the antenna and to processing circuitry, and configured to condition signals communicated between the antenna and the processing circuitry;
the processing circuitry being configured to:
receive an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements, wherein the indication is included in a Medium Access Control Control Element (MAC CE); and
perform one or more GNSS measurements in accordance with the indication.

40. The UE of claim 39, wherein the processing circuitry is further configured to:
receive a configuration for the UE to report the GNSS position fix time duration; and
report the GNSS position fix time duration upon entering RRC_CONNECTED state.

41. The UE of claim 39, wherein the processing circuitry is further configured to receive, with or in association with the indication, one or more of any of the following:
an indication of a GNSS measurement gap for performing the GNSS measurement(s);
an indication of whether the GNSS measurement gap for performing the GNSS measurement(s) is set to a closest value greater than or equal to a UE-reported value for a GNSS position fix time duration or to a value indicated by the network node anchoring the feeder link of a connection between the UE and the network node, via an NTN node;
an indication of whether the UE is to report its GNSS position fix time duration after performing a next GNSS measurement;
an indication of whether the UE is to report its GNSS position fix time duration every time it performs a GNSS measurement;
an indication of whether the UE needs to report one, two, or three values for the GNSS position fix time duration;
an indication of whether the UE needs to report more than one value for the GNSS position fix time duration;
a number of GNSS measurements for which a measurement configuration provided to the UE is valid; and
a time period during which a GNSS measurement gap configuration provided to the UE is valid.

42. The UE of claim 39, wherein the processing circuitry is further configured to:
receive a message or command triggering an aperiodic GNSS measurement M₁, the UE having been provided with a GNSS measurement configuration indicated to be periodic; and
re-use at least part of the GNSS measurement configuration according to the rule:
if the UE was instructed to start the GNSS measurement gap for M₁ after the expiry of its GNSS validity duration, the UE will re-use the same GNSS measurement gap configuration for the next GNSS measurement M₂ unless it receives a new GNSS measurement trigger from the network for M₂, and
If the UE was instructed to start the GNSS measurement gap for M₁ before the expiry of its GNSS validity duration, the UE will “partially re-use” the same GNSS measurement gap configuration for the next GNSS measurement M₂ unless it receives a new GNSS measurement trigger from the network for M₂, where, “partial reuse” means that the UE will use the same configuration for the gap duration and/or GNSS assistance information for measurement M₂ (as indicated by the network for measurement M₁) except for the GNSS measurement trigger time instance, which will be set to start after the lapse of a time duration X following GNSS validity duration expiry, where X can be either fixed in the specification or configured by the network.

43. The UE of claim 39, wherein the processing circuitry is further configured to:
send, to a network node, GNSS assistance information; and
send, with or in association with the GNSS assistance information, information indicating a validity duration corresponding to all or part of the GNSS assistance information.

44. A network node for assisting a user equipment (UE) to perform Global Navigation Satellite System (GNSS) measurements in a wireless network, the network node comprising:
communication interface circuitry; and
processing circuitry operatively coupled to the communication interface circuitry and configured to:
send, to the UE, an indication of a selection of a type of GNSS measurement to be performed by the UE from among at least two of: an aperiodic GNSS measurement, an event-based GNSS measurement, a time-periodic GNSS measurement, and a periodic GNSS measurement, wherein ‘periodic GNSS measurement’ encompasses both time-periodic GNSS measurements and event-based GNSS measurements, wherein the indication is included in a Medium Access Control Control Element (MAC CE);
receive, from the UE, GNSS assistance information; and
receive, from the UE, with or in association with the GNSS assistance information, information indicating a validity duration corresponding to all or part of the GNSS assistance information.
